(19) United States
(12) Patent Application Publication
(10) Pub. No.: US 2014/0096140 A1
(43) Pub. Date: Apr. 3, 2014

(54) MANAGING A SERVICE PROVIDER'S CUSTOMER QUEUE

(71) Applicant: INTERNATIONAL BUSINESS MACHINES CORPORATION, Armonk, NY (US)

(72) Inventors: Adilson B. de Aquino, Mairipora (BR); Gustavo Fiorante, Sao Paulo (BR); Pablo R.M. Gonzalez, Sao Paulo (BR); Kusuma Govindaraju, Sao Paulo (BR); Thiago C. Rotta, Sao Paulo (BR)

(73) Assignee: International Business Machines Corporation, Armonk, NY (US)

(21) Appl. No.: 13/632,234

(22) Filed: Oct. 1, 2012

(51) Int. Cl. G06F 9/46

(52) U.S. Cl. 718/103

(57) ABSTRACT

A method for scheduling a service. The method includes receiving a request for service at a service provider location from a requester; analyzing the request for service and generating a passcode; providing the passcode to the requester, the passcode including an estimated time when attendance is requested at the service provider; prioritizing the passcode according to one or more business rules; periodically updating the estimated time corresponding to the passcode when attendance is requested at the service provider location according to the one or more business rules; and notifying the requester of the most recent estimated time when attendance is requested at the service provider location. The method may be performed on one or more computing devices. Also included is a system for scheduling a service and a computer program product.

### BACKGROUND

The present exemplary embodiments relate to a method and system to prioritize the attendance of people by looking for a service level optimization and more particularly, relate to a solution to intelligently manage queues and provide an accurate estimate for a given wait time.

Queues may form in various places for various reasons. People may form queues, for example, at point of sale locations, hospitals, banks, restaurants and other customer service locations. The services provided at customer service locations may take on the characteristic of a good or bad service, depending on how the service is provided to the service requester (i.e., the user or consumer) and how long the service requester has to wait in the queue.

A common procedure in managing queues is to provide a number which reserves a place in the queue for the service requester until called by the service provider. Often, the service requester may have to wait in the queue longer than expected, thereby lowering the quality of service of the service provider.

### BRIEF SUMMARY

The various advantages and purposes of the exemplary embodiments as described above and hereafter are achieved by providing, according to a first aspect of the exemplary embodiments, a method for scheduling a service. The method including: receiving a request for service at a service provider location from a requester; analyzing the request for service and generating a passcode; providing the passcode to the requester, the passcode including an estimated time when attendance is requested at the service provider; identifying an electronic device of the requester upon arrival of the requester at the service provider location; prioritizing the passcode according to one or more business rules; periodically updating the estimated time corresponding to the passcode when attendance is requested at the service provider location according to the one or more business rules; and notifying the requester's electronic device of the most recent estimated time when attendance is requested at the service provider location, the notifying including the requester's passcode. The steps of the method may be performed on one or more computing devices.

According to a second aspect of the exemplary embodiments, there is provided a computerized system for scheduling a service. The system comprising: a module to receive a request for service at a service provider location from a requester; a module to analyze the request for service and generating a passcode; a module to provide the passcode to the requester, the passcode including an estimated time when attendance is requested at the service provider; a module to identify an electronic device of the requester upon arrival of the requester at the service provider location; a module to prioritize the passcode according to one or more business rules; a module to periodically update the estimated time corresponding to the passcode when attendance is requested at the service provider location according to the one or more business rules; and a module to notify the requester's electronic device of the most recent estimated time when attendance is requested at the service provider location, the notification including the requester's passcode. The modules may be on one or more computing devices.

According to a third aspect of the exemplary embodiments, there is provided a computer readable program product for scheduling a service. The computer program product comprising: a nontransitory computer readable storage medium having computer readable program code embodied therewith, the computer readable program code comprising: computer readable program code configured to receive a request for service at a service provider location from a requester; computer readable program code configured to analyze the request for service and generate a passcode; computer readable program code configured to provide the passcode to the requester, the passcode including an estimated time when attendance is requested at the service provider; computer readable program code configured to identify an electronic device of the requester upon arrival of the requester at the service provider location; computer readable program code configured to prioritize the passcode according to one or more business rules; computer readable program code configured to periodically update the estimated time corresponding to the passcode when attendance is requested at the service provider location according to the one or more business rules; and computer readable program code configured to notify the requester's electronic device of the most recent estimated time when attendance is requested at the service provider location, the notification including the requester's passcode.

### BRIEF DESCRIPTION OF SEVERAL VIEWS OF THE DRAWINGS

The features of the exemplary embodiments believed to be novel and the elements characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is an illustration of the method of the exemplary embodiments.

FIG. 2 is a flow chart illustrating the method of the exemplary embodiments.

FIG. 3 is a block diagram of a computer hardware environment that may be used in practicing the exemplary embodiments.

### DETAILED DESCRIPTION

The exemplary embodiments provide a way to intelligently manage queues so as to improve a service requesters' experience in waiting for a service. The exemplary embodiments include a system hosted, for example, on the internet cloud which a service requester (i.e., user) may access and cause the system to generate a passcode. As soon as the passcode is generated, the system may send it out to the service requester's device, such as a cellphone, and provide the service requester an estimation on how long that passcode will take to be called for attendance, thereby providing to the service requester the possibility to use the idle time outside of the service provider location. Once the service requester arrives at the service provider location, the system may identify the requester's device by using a Bluetooth standard, Wi-Fi standard or other communication protocol and update the current attendance queue.

In order to make an informed decision on how to allocate the service requester into the queue, the system may match information provided by the service requester when the service requester first accessed the system. Such information may include the type of service being requested, date, time and priority. The system may also consider the arrival time and waiting time while the service requester is at the service location to make a real-time decision with respect to the service requester's place in the queue and possibly change the service requester's place in the queue. Furthermore, the system may keep track of the time and provide to the service requester a new estimation of how long it will take until the user's passcode is called for attendance.

The exemplary embodiments have several advantages. The generation of passcodes before the service requester arrives at the service location may allow the service requester to know in advance the estimated waiting time in order to enable the service requester to use the idle time outside of the service provider location for activities other than waiting in a queue. The automatic device discovery of the requester's device at the service provider's location saves time in identifying that the service requester has arrived at the service provider location. The automatic queue reallocation according to predefined business rules allows the system to organize the upcoming passcodes in real-time. Finally, the exemplary embodiments are flexible for different types of customer service providers enabling companies of different sizes and segments to provide a more efficient waiting service for its customers.

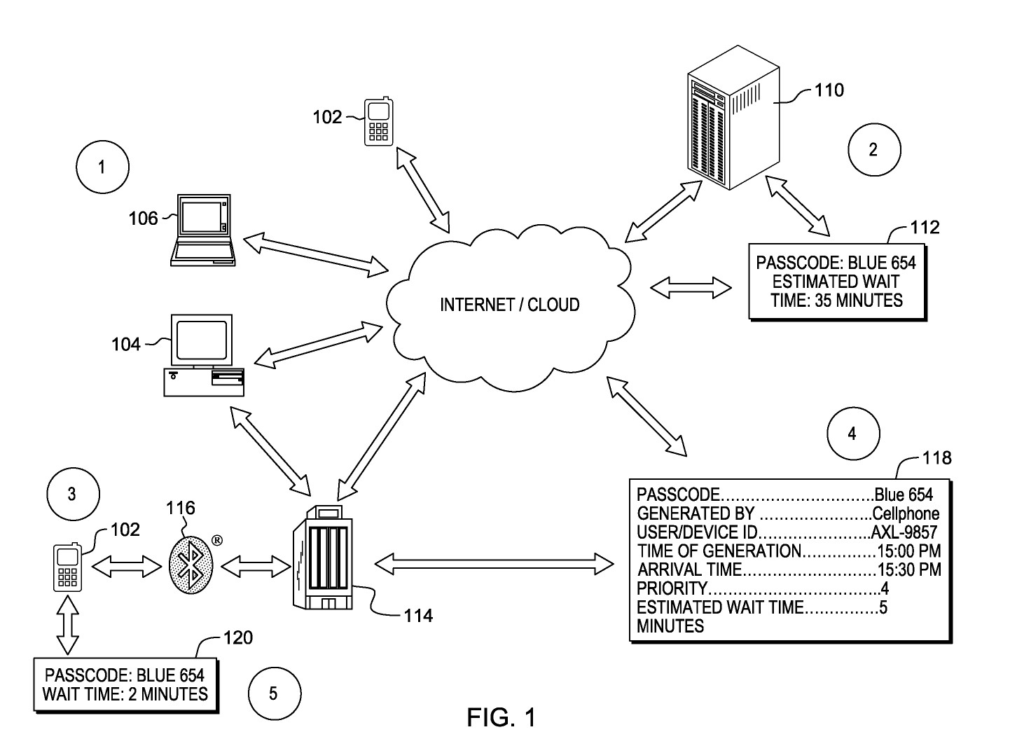

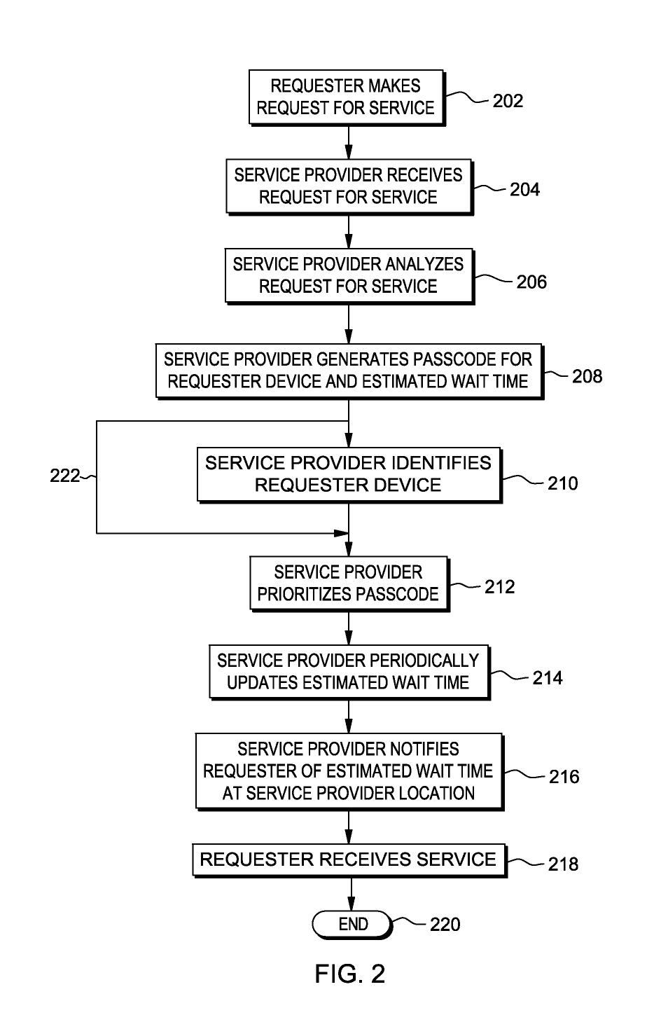

Referring to the Figures in more detail, FIG. 1 illustrates the exemplary embodiments and FIG. 2 is a flow chart that illustrates a method of the exemplary embodiments. Both of FIGS. 1 and 2 are referred to in the following discussion. A requester (i.e., user) desires to use the services of a service provider such as a hospital, bank, restaurant, etc. The requester knows that there may be a queue for service so before proceeding to the service location, the requester may let the service provider know that the requester is interested in the services of the service provider and request in some manner that the requester be placed on the queue waiting for service. So, in a first step of the method, the requester may make a request for service from the service provider (box 202, FIG. 2) and in return the requester may receive a passcode provided by the service provider. In one exemplary embodiment, the requester may simply request a passcode. In another exemplary embodiment, the requester may request a service and in return, the service provider may provide the passcode.

Referring to FIG. 1, in the portion numbered “1”, the requester may make the request to the service provider by using an electronic device. The requester may make the request from a mobile device, such as a cellphone 102, by sending a Short Message Service (SMS) message; a laptop personal computer 106 by accessing a given area of the service provider website; or a terminal 104 in the service provider location by printing or requesting a passcode. The request is transmitted through the internet/cloud (hereafter just cloud) 108 to the service provider's computing device 110 and is received by the service provider (box 204, FIG. 2). Alternatively, the computing device 110 may be hosted in the cloud, and be available for the service provider's use, on demand. The computing device 110 may be any type of computing device including a desktop computer, laptop computer, workstation computer or a mainframe computer. It is anticipated that portable devices such as smartphones may someday have sufficient computing capability to perform in the exemplary embodiments.

When the requester makes the request for service to the service provider, the requester may have to provide some information to the service provider. The type of information that the requester provides may depend on the type of service requested. For example, for a restaurant reservation, the requester may simply request a passcode and provide no further information. As another example, for a bank transaction, the requester may be asked to provide a name, bank account number and telephone number. As a further example, for a hospital service, the requester may have to give more information such as a description of the service requested, name, telephone number, address, insurance information and referring doctor.

The request may be analyzed by the service provider's computing device 110 (box 206, FIG. 2) and a passcode with an estimated wait time for attendance is generated as a response (box 208, FIG. 2) and provided to the requester's device, 102, 104, 106. The requester is prioritized according to others waiting in the queue for service. The passcode generated and estimated wait time 112 are also illustrated in portion number “2” of FIG. 1.

The passcodes generated preferably are not sequential but miscellaneous names (countries, objects, etc) in order to identify the service or categorize it. For example, in a bank request for the category “Open Account”, a password is generated such as “Sao Paulo” or “New York”, for the category “Investments”, a password is generated such as “Yellow” or “Blue” among others depending on the kind of service and its priorities within the category, followed by a number. Example: Sao Paulo 20, New York 33, Yellow 10, Blue 23 etc. The passcodes so generated are easier to remember and they may mask the concept of sequential passcodes. The passcode 112 shown in FIG. 1 is “Blue 654” and an estimated wait time of 35 minutes.

Preferably, the passcode has been sent to the requester's mobile device, such as cellphone 102 or laptop personal computer 106. The mobile device 102 preferably has a standard communication protocol such as Bluetooth or Wi-Fi. When the requester approaches the service location, the service provider may identify the requester device (box 210, FIG. 2) through this standard communication protocol.

In the case of the Bluetooth standard, a bluetooth standard device is always active searching for devices on the service provider location so that when the requester arrives at the service provider location, their device is identified and the service provider logs the requester automatically. The requester may also check in at a monitor to see if their device has been discovered by the service provider. The Bluetooth device must be in “visible” state in order to be discovered and paired. The first time the requester visits the service provider's location, the requester must pair their Bluetooth device with the service provider and accept the service provider's pair request. On subsequent visits to the service provider's location, pairing is not necessary and the requester's Bluetooth device becomes automatically recognized.

Referring to FIG. 1, in the portion number “3”, the requester's device, for example mobile device 102 but could also be the requester's laptop personal computer 106, is in proximity to the service provider's location 114. Through the Bluetooth communication protocol 116, the requester's mobile device 102 is recognized by the service provider's location 114. The service provider's location 114 may communicate with the service provider's computing device 110 through the cloud 108 to obtain information about the requester and provide the requester's arrival time to the computing device 110.

Wi-Fi may also be used as the communication protocol but in this case, the requester may need to enter a password (provided by the service location) to access the service provider's Wi-Fi network. Thereafter, the requester may continue to be recognized by the service provider as long as the password has not changed.

If the requester does not have a mobile device, the requester may receive his passcode while at the service provider's location 114 through the service provider's terminal 104. The requester may also check on any updates via the terminal 104 or perhaps a monitor at the service provider's location 114. Since the requester may not have a mobile device, there is no mobile device to identify and so this requester may skip the step identified in box 210, FIG. 2, and proceed directly to the step identified in box 212, FIG. 2, as indicated by line 222.

The service provider through computing device 110, upon receiving information that the requester has arrived at the service provider's location 114, may re-prioritize the requester's placement in the queue through the generated passcode (box 212, FIG. 2). The re-prioritization may be done according to the kind of service, arrival time, priority weight, existing queue, whether physically disabled or pregnant, number of clerks available or any other predefined business rule. In some types of service providers, a pre-sorting may be necessary and re-prioritizing according to the user's symptoms, circumstances and so on, such as in a hospital. Even for the requester that obtains his passcode at the service provider's location 114, the requester's position in the queue may be re-prioritized based on the same factors above but the requester would have to check the terminal 104 or any available monitors for updates.

The service provider may consider indexes, variables, key performance indicators, service level agreements and formulas for its calculations and determination of priority. Those parameters are not fixed but can vary depending on the service provider, and are customizable to best fit business needs.

Referring to FIG. 1, in portion numbered “4”, the requester has been prioritized by computing device 110 to result in the prioritization 118 which may be stored in computing device 110. The prioritization 118 may show, for example, the requester's passcode, mobile device (if any), identification of the requester's device, if any (such as a MAC address), time of generation of the passcode, arrival time at the service provider's location, priority and estimated wait time.

The estimated wait time for attendance may be updated and sent to the requester periodically, such as every 15 minutes (box 214, FIG. 1) by the service provider's computing device 110. The requester may be notified of the estimated wait time at the service provider location (box 216, FIG. 2). Also shown in FIG. 1, in portion numbered “5”, the requester's mobile device 102 has been updated 120 to show an estimated wait time of 2 minutes. For the requester without a mobile device, this requester would have to check the terminal 104 at the service provider's location 114 or any available monitors for the updates.

Close to the expiration of the estimated wait time, the requester may receive service from the service provider (box 218, FIG. 1) and thereafter, the method ends (box 220, FIG. 1).

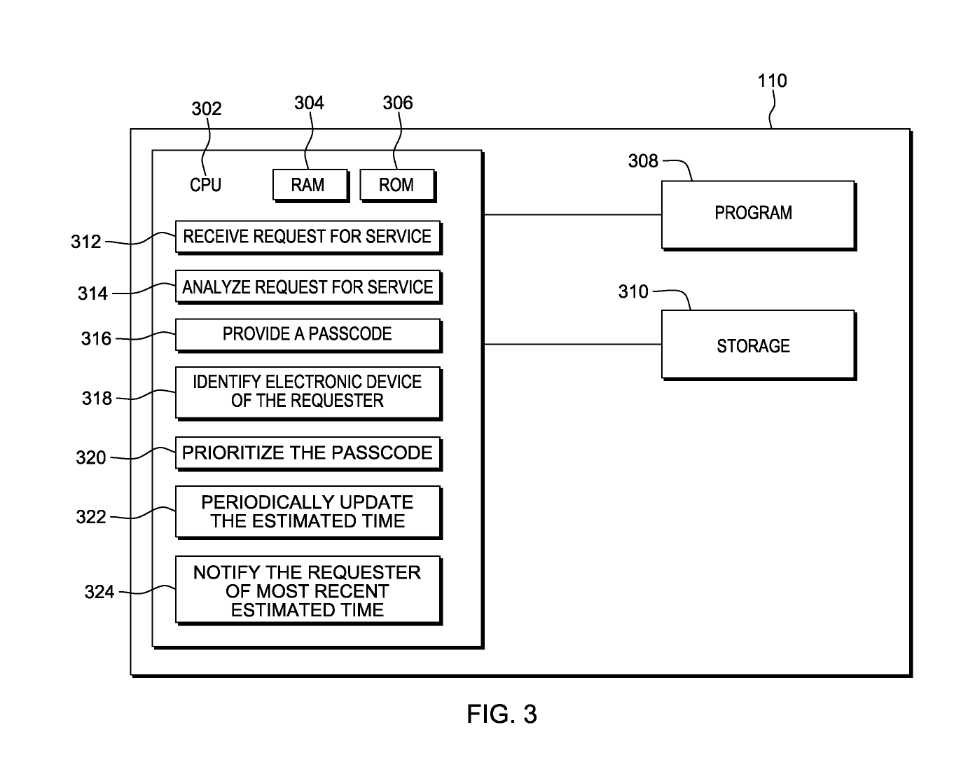

The exemplary embodiments may further include a computerized system for scheduling a service. The system includes the computing device 110 shown in FIG. 1. The computing device 110 is further described in FIG. 3.

The computing device 110 may include at least one central processing unit (CPU) 302, random access memory (RAM) 304, read-only memory 306 and other components. Resident in the computing device 110, or peripheral to it, may be a storage device 310 of some type such as a hard disk, floppy disk drive, CD-ROM drive, tape drive or other storage device.

Further included in computing device 110 are program instructions 308 that may be tangibly and non-transitorily embodied in storage device 310 or peripheral thereto in another storage medium which, when read and executed by the CPU 302, causes the computing device 110 to perform the steps necessary to execute the processes of the exemplary embodiments.

The CPU 302 may further include one or more modules for executing parts of the exemplary embodiments. Thus, there may be a module 312 to receive a request for service at a service provider location from a requester. There also may be a module 314 to analyze the request for service and generating a passcode. There may be a module 316 in the at least one CPU 302 to provide a passcode to the requester, the passcode including an estimated time when attendance is requested at the service provider. There may also be a module 318 in the at least one CPU 302 to identify an electronic device of the requester upon arrival of the requester at the service provider location. The at least one CPU 302 may further include a module 320 to prioritize the passcode according to one or more business rules, a module 322 to periodically update the estimated time when attendance is requested at the service provider location according to the one or more business rules, and a module 324 to notify the requester of the most recent estimated time when attendance is requested at the service provider location.

### EXAMPLES

Some examples are given of prioritization. The formulas used are just examples of formulas that may be used and they are adaptable to different situations where prioritization of people in queues may occur.

In the examples that follow, there are 5 types of services being provided by the service provider in this scenario and only 2 indexes, type of service and person's age. However, the solution is generic enough in which the service provider may provide more than 5 types of services and more than 2 indexes.

| INDEXES | WEIGHT |
|---|---|
| Type of Service | Between 0 and 5 |
| Person's age (only people between | Between 0 and 5 |
| 60 and 100 years old) | |

| FORMULAS TITLE | FORMULAS |
|---|---|
| Age Weight | SUBTRACTION(person age, min age to receive |
| | some weight) * (DIV(Maximum Age Weight, |
| | SUBTRACTION(max age to receive some |
| | weight, min age to receive some weight))) |
| Criticality | DIV(SUM(age weight, type of service weight, |
| | N indexes weight), amount of N indexes) |
| Priority | DIV(waiting time or 1 in case it is 0 minute, |
| | MULT(estimated time for attendance, criti- |
| | cality)) + criticality |
| Estimated time | MULT(average time for attendance, amount of |
| for attendance | people in the queue or current position in the |
| | queue for reallocation) |
| Waiting time | SUBTRACTION(actual time, time when waiting- |
| | passcode was generated) |

The following scenario considers the formulas' tables above to better represent a real situation among three users, with different characteristics, which have generated their passcodes at the same time and same day:

| Name: | Bob | Karen | Jim |
|---|---|---|---|
| Age: | 27 | 70 | 61 |
| Type of Service | 2 | 1 | 3 |
| Waiting-passcode | 2:30 PM | 2:30 PM | 2:30 PM |
| generation time | | | |
| Arrival time at the | 3:00 PM | 3:15 PM | 3:18 PM |
| service provider | | | |
| location (considering | | | |
| device's pairing | | | |

### Age Weight:

Determining the Age Weight of each person may be determined as follows using the Age Weight formula:

SUBTRACTION(person age,min age to receive some weight)*(DIV(Maximum Age Weight,SUBTRACTION(max age to receive some weight,min age to receive some weight))):

For Bob (age 27): Not applicable because Bob is less than 60 years old. Age weight=0.

### For Karen (age 70): SUBTRACTION(70, 60)*DIV(5, SUBTRACTION(100, 60))

10*DIV(5,40)

10*0.125=Age weight 1.25

### For Jim (Age: 61): SUBTRACTION(61, 60)*DIV(5, SUBTRACTION(100, 60))

1*0.125=Age weight 0.125

### Criticality:

Determining the Criticality of each person may be determined as follows using the Criticality formula:

DIV(SUM(age weight,type of service weight,N indexes weight),amount of Nindexes)

### For Bob: DIV(SUM(0, 2), 2)=Criticality 1

### For Karen: DIV(SUM(1.25, 1), 2)=Criticality 1.125

### For Jim: DIV(SUM(0.125, 3), 2)=Criticality 1.5625

### Priority:

The initial Priority for each person may be determined using the following formula and assuming there are no other requesters in the queue:

DIV(waiting time or 1 in case it is 0 minute,MULT(estimated time for attendance,criticality))+criticality

Estimated time for attendance: 0 (immediately)

### For Bob: DIV(1, MULT(1, 1))+1=Priority 2

### For Karen: DIV(1, MULT(1, 1.125))+1.125=Priority 2.005

### For Jim: DIV(1, MULT(1, 1.5625))+1.5625=Priority 2.202

Prioritization is in the order of highest priority number to lowest priority number. Thus, the order of prioritization would be Jim (first), Karen (second) and Bob (third).

As another example, it may be assumed that the current time is 3:20 PM and the arrival time at the service location is considered. It is also assumed that the maximum estimated wait time for attendance is 30 minutes. The three persons in this example may be shown as follows:

| NAME | BOB | KAREN | JIM |
|---|---|---|---|
| Arrival Time: | 3:00 PM | 3:15 PM | 3:18 PM |
| Current Time: | 3:20 PM | 3:20 PM | 3:20 PM |
| Waiting Time: | 20 minutes | 5 minutes | 2 minutes |

Using the above formula for determining Priority, Priority may be determined as follows:

### For Bob: DIV(20, MULT(30, 1))+1=Priority 1.66

### For Karen: DIV(5, MULT(30, 1.125))+1.125=Priority 1.273

### For Jim: DIV(2, MULT(30, 1.5625))+1.5625=Priority 1.602

Prioritization, again, is in the order of highest priority number to lowest priority number. Thus, the order of prioritization would be Bob (first), Jim (second) and Karen (third).

As will be appreciated by one skilled in the art, aspects of the exemplary embodiments may be embodied as a system, method, service method or computer program product. Accordingly, aspects of the exemplary embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the exemplary embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible or non-transitory medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the exemplary embodiments may be written in any combination of one or more programming languages, including an object oriented programming language such as Java, Smalltalk, C++ or the like and conventional procedural programming languages, such as the “C” programming language or similar programming languages or even Microsoft Excel/Access. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the exemplary embodiments have been described above with reference to flowchart illustrations and/or block diagrams of methods, apparatus (systems) and computer program products according to the exemplary embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and/or block diagrams in the Figures illustrate the architecture, functionality, and operation of possible implementations of systems, methods, service methods and computer program products according to the exemplary embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be apparent to those skilled in the art having regard to this disclosure that other modifications of the exemplary embodiments beyond those embodiments specifically described here may be made without departing from the spirit of the invention. Accordingly, such modifications are considered within the scope of the invention as limited solely by the appended claims.

What is claimed is:

1. A method for scheduling a service comprising:
receiving a request for service at a service provider location from a requester;
analyzing the request for service and generating a passcode;
providing the passcode to the requester, the passcode including an estimated time when attendance is requested at the service provider;
prioritizing the passcode according to one or more business rules;
periodically updating the estimated time corresponding to the passcode when attendance is requested at the service provider location according to the one or more business rules; and
notifying the requester of the most recent estimated time when attendance is requested at the service provider location, the notifying including the requester's passcode;
wherein the steps of the method are performed on one or more computing devices.

2. The method of claim 1 wherein prioritizing includes taking into account the time of arrival by the requester at the service provider location.

3. The method of claim 1 wherein between providing the passcode to the requester and prioritizing the passcode, further comprising identifying an electronic device of the requester upon arrival of the requester at the service provider location.

4. The method of claim 1 wherein receiving a request for service includes a request for a passcode.

5. The method of claim 1 wherein the request for service includes information identifying the requester.

6. The method of claim 3 wherein identifying an electronic device of the requester includes identifying the electronic device by a Bluetooth standard communication protocol.

7. The method of claim 3 wherein identifying an electronic device of the requester includes identifying the electronic device by a Wi-Fi standard communication protocol.

8. A computerized system for scheduling a service comprising:
a module to receive a request for service at a service provider location from a requester;
a module to analyze the request for service and generating a passcode;
a module to provide the passcode to the requester, the passcode including an estimated time when attendance is requested at the service provider;
a module to identify an electronic device of the requester upon arrival of the requester at the service provider location;
a module to prioritize the passcode according to one or more business rules;
a module to periodically update the estimated time corresponding to the passcode when attendance is requested at the service provider location according to the one or more business rules; and
a module to notify the requester of the most recent estimated time when attendance is requested at the service provider location, the notification including the requester's passcode;
wherein the modules are on one or more computing devices.

9. The system of claim 8 wherein the module to prioritize includes taking into account the time of arrival by the requester at the service provider location.

10. The system of claim 8 further comprising a module to identify an electronic device of the requester upon arrival of the requester at the service provider location.

11. The system of claim 8 wherein the module to receive a request for service includes a request for a passcode.

12. The system of claim 8 wherein the request for service includes information identifying the requester.

13. The system of claim 10 wherein the module to identify an electronic device of the requester includes the capability to identify the electronic device by a Bluetooth standard communication protocol.

14. The system of claim 10 wherein the module to identify an electronic device of the requester includes the capability to identify the electronic device by a Wi-Fi standard communication protocol.

15. A computer readable program product for scheduling a service, the computer program product comprising:
a nontransitory computer readable storage medium having computer readable program code embodied therewith, the computer readable program code comprising:
computer readable program code configured to receive a request for service at a service provider location from a requester;
computer readable program code configured to analyze the request for service and generate a passcode;
computer readable program code configured to provide the passcode to the requester, the passcode including an estimated time when attendance is requested at the service provider;
computer readable program code configured to identify an electronic device of the requester upon arrival of the requester at the service provider location;
computer readable program code configured to prioritize the passcode according to one or more business rules;
computer readable program code configured to periodically update the estimated time corresponding to the passcode when attendance is requested at the service provider location according to the one or more business rules; and
computer readable program code configured to notify the requester's electronic device of the most recent estimated time when attendance is requested at the service provider location, the notification including the requester's passcode.

16. The computer readable program product of claim 15 wherein computer readable program code configured to prioritize includes computer readable program code configured to take into account the time of arrival by the requester at the service provider location.

17. The computer readable program product of claim 15 wherein between computer readable program code configured to provide the passcode to the requester and computer readable program code configured to prioritize the passcode, further comprising computer readable program code configured to identify an electronic device of the requester upon arrival of the requester at the service provider location.

18. The computer readable program product of claim 15 wherein computer readable program code configured to receive a request for service includes a request for a passcode.

19. The computer readable program product of claim 15 wherein the request for service includes information identifying the requester.

20. The computer readable program product of claim 15 wherein computer readable program code configured to identify an electronic device of the requester includes computer readable program code configured to identify the electronic device by a Bluetooth standard communication protocol.

21. The computer readable program product of claim 15 wherein computer readable program code configured to identify an electronic device of the requester includes computer readable program code configured to identify the electronic device by a Wi-Fi standard communication protocol.
